(19) United States
(12) Patent Application Publication
(10) Pub. No.: US 2003/0026742 A1
(43) Pub. Date: Feb. 6, 2003

(54) Thermocouple protection tube

(76) Inventors: Chi-Ming Wu, Diamond Bar, CA (US); Hong-Hai Dong, Kunshan City (CN)

Correspondence Address: STEPHEN H. CAGLE, HOWREY, SIMON, ARNOLD & WHITE, LLP, 750 BERING DRIVE, HOUSTON, TX, 77057, US

(21) Appl. No.: 10/195,670

(22) Filed: Jul. 15, 2002

(30) Foreign Application Priority Data
Jul. 15, 2001 (CN) 01244854.0

(51) Int. Cl. G05D 23/00

(52) U.S. Cl. 422/129; 422/187; 422/105; 422/109

(57) ABSTRACT

A thermocouple protection tube is designed such that it is capable of adjusting the length of thermocouple inside reactor after assembly. The design includes an outer casing, an inner casing and a means for fixing the relative position of the outer casing and the inner casing. The inner casing is positioned relative to, and within the outer casing. The fixing means temporarily fixes the relative position of inner casing and outer casing. The disclosed design permits the adjustment of the thermocouple length inside thermocouple protection tube according to the relative thickness the refractory lining inside reactor.

A gasification reactor generally comprises a reaction zone, made up of a vertical cylindrically shaped steel pressure vessel lined with refractory, and a quench chamber, such as shown in U.S. Pat. No. 2,809,104, which is incorporated herein by reference. A feed injector, such as shown in U.S. Pat. No. 2,928,460, which is incorporated herein by reference, may be used to introduce the feed streams into the reaction zone. In the reaction zone of a gasifier, the contents will commonly reach temperatures in the range of about 1,700° F. (927° C.) to 3,000° F. (1649° C.), and more typically in the range of about 2,000° F. (1093° C.) to 2,800° F. (153820 C.). Pressure will typically be in the range of about 1 atmospheres (101 kPa) to about 250 atmospheres (25331 kPa), and more typically in the range of about 15 atmospheres (1520 kPa) to about 150 atmospheres (15,199 kPa), and even more typically in the range of about 60 atmospheres (6080 kPa) to about 80 atmospheres (8106 kPa). See U.S. Pat. No. 3,945,942 describing a partial oxidation feed injector assembly. See U.S. Pat. No. 5,656,044 describing a method and an apparatus for the gasification of organic materials. See also U.S. Pat. Nos. 5,435,940, 4,851,013, and 4,159,238 describing a few of the many gasification processes known in the prior art. The entire disclosures of the above referenced patents are hereby incorporated by reference and relied upon.

It is well known in the prior art that the length of a reactor thermocouple has a fixed length inside reactor during operation of the reactor. However, the substances generated in the reactor may flow under conditions of high temperature, and thus cause the erosion and abrasion of the hot surface of the reactor lining. Such erosion and abrasion often results in the reduction of the thickness of the lining. A further result of the erosion and abrasion is that it generates considerable uncertainty of the supposed thermocouple length within the thermocouple protection tube. If the thermocouple in the thermocouple protection tube is too long, the thermocouple may be exposed to direct abrasion and damaged in a short period of time and thus be unable to measure reactor temperature. On the other hand if the thermocouple is not long enough, the thermocouple won't be able to measure reactor temperature correctly which in turn may result in an operationally difficult reactor. While the above difficulties and deficiencies have been known in the art for many years, there remains an unmet need for a resolution to resolve the problem that the length of thermocouple in thermocouple nozzle can not be adjusted during operation.

### SUMMARY OF THE INVENTION

The present invention is generally directed to a thermocouple protection tube, especially one for use in a chemical reactor and preferably a gasification reactor that permits the user to adjust the length of the thermocouple within the reactor. As generally disclosed herein, the thermocouple protection tube includes an outer casing, an inner casing and a means for fixing the relative position of the inner and outer casing.

In one specific and illustrative embodiment, a first thread is made on the inner surface of the outer casing. A second thread, that matches the first thread on the inner surface of the outer casing, is made on the outer surface of the inner casing. This arrangement permits the inner casing to be moved back and forward, relative to in the outer casing, through mechanical interactions of the first thread on the inner surface of the outer casing and the second thread on the outer surface of the inner casing. The means for fixing the relative position of the inner and outer casings includes a locking nut, whose thread is made to match the second thread on the outer surface of inner casing. Thus the locking nut can move freely along the inner casing. During operation as a means for fixing the relative position of the inner casing and outer casing, the locking nut is fictionally engaged to the outer casing so as to fix the relative position of the outer casing and inner casings. When adjustment is desired, the locking nut is loosened away from the outer casing so that the inner casing can be adjusted inside outer casing. This arrangement permits the thermocouple, which is fixed to the inner casing, to be adjustable. That is to say, the relative position of thermocouple to the reactor can be adjusted by adjusting the relative position of outer casing and inner casing. However, just as important, the relative position of the thermocouple to the reactor can be fixed for prolonged periods of time by fixing the relative position of the outer casing and inner casing by fictionally engaging the locking nut with the outer casing. So the adjustment of thermocouple length inside thermocouple nozzle is achieved through the stretching out and drawing back of inner casing and fixing up by the nut.

Another and illustrative alternative embodiment of the present invention includes a means for fixing the relative position of the inner casing and outer casing that utilizes a compression type arraignment. In such an illustrative embodiment, the outer casing includes at least one locking gap or groove and the outer surface of the outer casing has a third thread on its outer surface. A compression nut, whose thread is made to match the third thread on the surface of outer casing so that it can move freely along the outer casing, is used as the fixing device. During assembly, the inner casing is inserted into the outer casing from the end with gaps on it so as to form a compression type fitting. The compression nut is then fictionally fastened to the outer casing by way of the third thread. This in turn slightly compresses the locking gap so as to fix the relative position of the outer casing and inner casing. When adjustment is required, the compression nut is either loosened or completely removed away from the outer casing so that the inner casing can be moved freely inside the outer casing.

Yet another illustrative embodiment of the present invention includes a means for fixing the relative positions of the inner casing and the outer casing that includes the use of one or more locking pins or screws. In one such illustrative embodiment, there is at least one locking screw hole in the outer casing into which a locking screw is threaded. As previously disclosed above, the inner casing is inserted into the outer casing and the relative position can be adjusted. When a fixed position is desired, a locking screw is inserted into the locking screw hole and thus become fictionally engaged with the outer surface of the inner casing. This fixes the relative position of the outer casing and inner casing. When adjustment of the relative positions of the inner casing and outer casing is desired, the locking screw is disengaged from the outer surface of the inner casing and again the inner casing can be moved relative to the outer casing.

One of skill in the art should appreciate and understand that it can be concluded from the above mentioned specific structures that the present invention enables free adjustment of the thermocouple length within the thermocouple protection tube. This is in contrast with the length of prior art thermocouple protection tubes in which the relative position/length of the thermocouple is fixed after assembly. It should be appreciated by such a skilled person that a fixed length thermocouple is troublesome in use and thus results in higher operational expenses. In contrast, the present invention enables convenient adjustment and usage of the thermocouple and thus may result in reduced operational expenses.

These and other features of the present invention are more fully set forth in the following description of preferred or illustrative embodiments of the invention.

### BRIEF DESCRIPTION OF THE DRAWINGS

The description is presented with reference to the accompanying drawings in which:

FIG. 1 is the schematic diagram of an outer casing that is threaded on its inner surface.

FIG. 2 is the schematic diagram of the inner casing threaded on its outer surface for use with the outer casing shown in FIG. 1.

FIG. 3 is the schematic diagram of the conjunction of the outer casing and inner casing shown in FIGS. 1 and 2.

FIG. 4 is the schematic diagram of the outer casing including a locking gap.

FIG. 5 is the schematic diagram of the inner casing for use with the outer casing shown in FIG. 4.

FIG. 6 is the schematic diagram of the conjunction of the outer casing and inner casing shown in FIGS. 3 and 4.

FIG. 7 is the schematic diagram of the outer casing including locking screw holes.

FIG. 8 is the schematic diagram of the inner casing for use with the outer casing shown in FIG. 7.

FIG. 9 is the schematic diagram of the conjunction of the outer casing and inner casing shown in FIGS. 7 and 8.

### DESCRIPTION OF ILLUSTRATIVE EMBODIMENTS

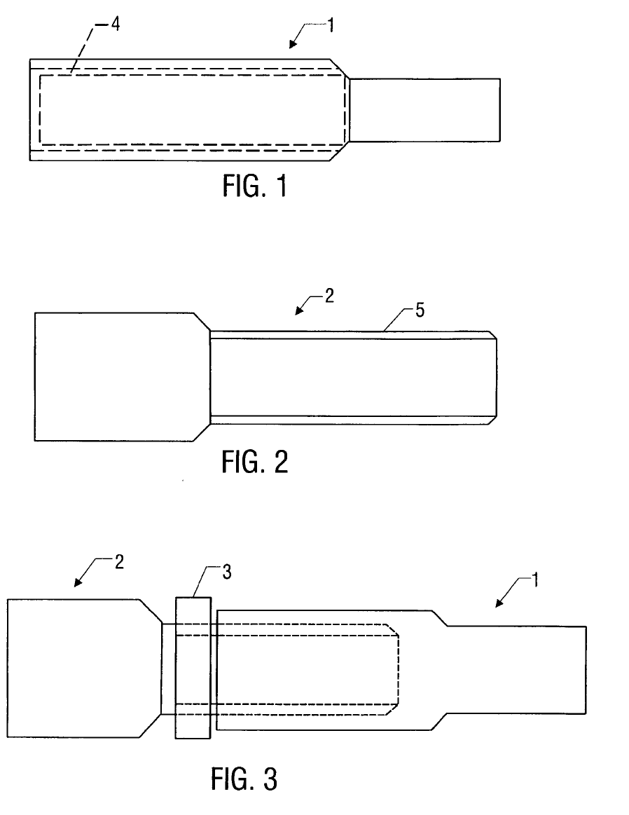

Turning now to the figures, as illustrated in FIGS. 1, 2 and 3, an illustrative embodiment of the thermocouple protection tube of the present invention includes an outer protection casing (1), inner protection casing (2) and means for fixing the relative position of the outer casing and the inner casing (3). As illustrated in FIG. 3, a thread locking arrangement, utilizing a locking nut serves as the means for the relative position of the outer casing and the inner casing. A first thread (4) is present on the inner surface of the outer casing (1). A second thread (5) is made on the outer surface of the inner casing (2). The first thread (4) and the second thread (5) match each other and thus through threadable and adjustable contact, the first thread (4) and second thread (5) allow for the adjustment of the relative position of the inner casing (2) within the outer casing (1). The thread of the locking nut is made to match second thread (5) of the inner casing. so that it can move freely along inner casing (2). During operation the locking nut is threadably and adjustably fastened to the inner casing. When the relative position of the outer casing and the inner casing is to be fixed, the locking nut is adjusted so as to come into frictional contact with the outer casing as shown in FIG. 3. In such instance the interaction of the locking nut, the inner casing and the outer casing results in a what is commonly referred to as a “thread lock” or thread locking arrangement. One of skill in the art should appreciate that when adjustment is required, the locking nut is frictionally disengaged from the outer casing and this permits the adjustment of the relative position of the inner casing inside outer casing (1). Because the thermocouple is fixed in the inner casing (2) the thermocouples relative position is adjusted with that of the inner casing (2). Hence the length and position of thermocouple inside the thermocouple protection tube is adjustable. That is to say, the position of thermocouple inside thermocouple protection tube will be determined by fixing the relative position of inner casing (2) to the outer casing (1) with the nut. One of skill in the art should appreciate that the present invention will enable adjusting the position of thermocouple inside reactor and that such adjustment can be made according to the change in thickness of reactor refractory lining previously disclosed.

The present illustrative embodiment of the present invention is used to fix and adjust the relative position of the thermocouple to the reaction zone of a chemical reactor. Such a chemical reactor may preferably be a partial oxidation/gasification reactor as described above. In such an application, the thermocouple is fixed in its position in the inner casing. The inner casing is then inserted into the outer casing and locked into position. The entire thermocouple protection tube assembly is then inserted into the wall of the reactor and positioned so as to be able to measure the temperature in the reaction zone or other portion of the reactor. The inner casing may then be adjusted so that the thermocouple will reach the desired relative position within the reactor. Such relative position may depend upon several factors including the nature and conditions of the chemical reaction being carried out, the reactor lining thickness, as well as other factors that should be known to one of skill in the art. When in the desired relative position, the locking nut is frictionally engaged to the outer casing and the relative positions of the inner casing and thermocouple to the outer casing are thus fixed. When it is necessary to re-adjust the thermocouple position within the reactor, the locking nut is disengaged so that the inner casing can be adjusted relative to the outer casing. Alternatively, the relative position of the inner and outer casings can be locked into position and then the entire assembly positioned in the reactor. When it is necessary to re-adjust the thermocouple position within the reactor, the entire assembly is removed from the reactor, the locking nut is disengaged from the outer casing and the inner casing is adjusted so that the length of thermocouple inside the reactor according to the thickness of lining. The locking nut is then frictionally engaged to the outer casing to again fix the relative position of thermocouple and outer casing. Finally the outer casing reinserted into the reactor shell to secure the thermocouple position.

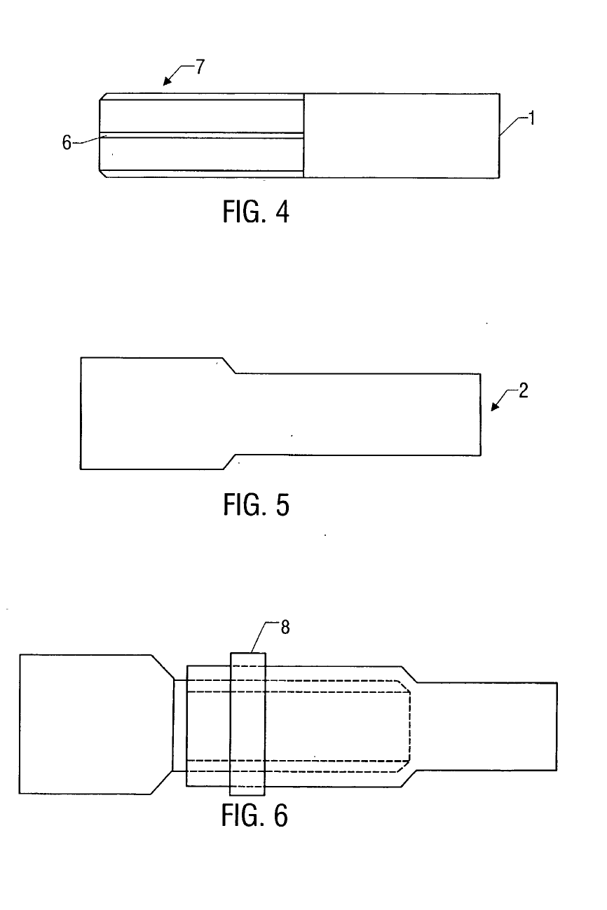

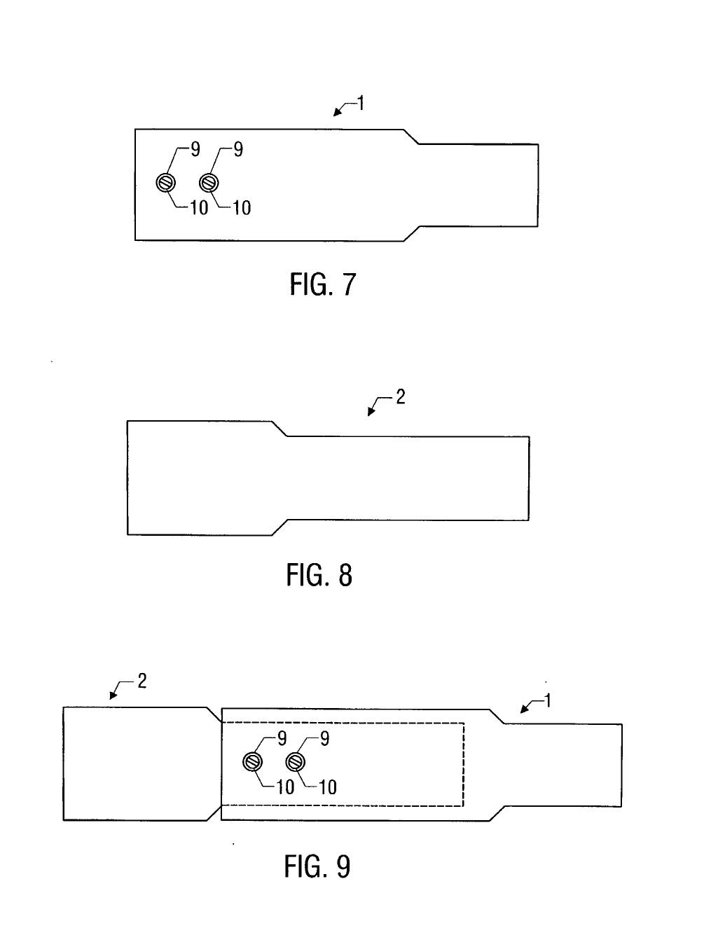

One of skill in the art should understand and appreciate that alternative means for fixing the relative positions of the outer and inner casings may be utilized. One such alternative is show in FIGS. 4, 5 and 6 which is illustrative of a compression fitting type means. As shown in FIG. 4, the outer casing has a third thread on it outer surface. Also included is one or more compression gaps (6) which extend to the contacting end of the outer casing. A compression nut (8), whose thread is made to match the third thread (7) on the surface of outer casing (1) so that it can move freely along the outer casing is also utilized. Generally, the inner casing (2) is inserted into the outer casing (1) from the end having the third thread and the compression gaps in it as shown in FIG. 7. The compression nut is then threadedly and adjustably fastened to the outer casing. As a result of the compression nut, the compression gaps slightly close and the outer casing comes into friction contact with the inner casing so as to fix the relative position of the outer casing and inner casing. When adjustment is required, the compression nut is loosened away from the outer casing (1) so that the inner casing (2) can be moved freely inside the outer casing (1).

Another alternative and illustrative embodiment of the means for fixing the relative position of the outer casing and the inner casing is shown in FIGS. 7, 8 and 9. As illustrated in FIG. 7, one or more one locking screw holes 9 exist in the outer casing 1. A corresponding locking screw 10 is threadably inserted into the corresponding locking screw hole. The inner casing 2 is inserted into the outer casing 1 from the end with the locking screw holes as shown in FIG. 9. In order to fix the relative position of the outer casing and the inner casing, the locking screw is inserted into the screw hole and is positioned so that it comes into frictional contact with the outer side of the inner casing. (not shown) As a result of the frictional contact between the locking screw and the inner casing, the relative position of the outer casing 1 and inner casing becomes fixed. When adjustment of the relative position of the outer casing and the inner casing is desired, the locking screw is frictionally disengaged from outer surface of the inner casing and thus the inner casing can be adjusted relative to the outer casing.

Though only three illustrative structures of the present invention are disclosed in detail above, one of ordinary skill in the art should appreciate and understand that there are many methods in practical use to realize the embodied goals of: 1) free movement of the inner casing relative to the outer casing, and 2) the ability to fix the relative position of the outer casing and inner casing. All such embodiments are considered to be within the scope of the present invention.

With regard to the materials from which the present invention may be constructed, one of skill in the art should appreciate and understand that the selection of such suitable materials will depend upon the specific conditions and application of the invention. Suitable and illustrative materials include metals, metal alloys, ceramics, composite structures of ceramic and metal or glass fiber and the like. While such selection may be important to a specific application depending upon the reaction conditions, such as temperature, pressure, and other considerations, the material selection is tangential to the concepts embodied by the present invention.

In view of the above disclosure, one of ordinary skill in the art should understand and appreciate that one illustrative embodiment of the present invention includes a thermocouple protection tube composed of an outer casing, an inner casing sized so as to be positioned inside the outer casing, and means for fixing the relative position of the inner casing within the outer casing. Both the outer casing and the inner casing have inner and outer surfaces that may be optionally threaded. In one such illustrative embodiment, the outer casing includes a first thread on the inner surface of the outer casing, and the inner casing includes a second thread on the outer surface of the inner casing. The first thread and the second thread are threadably cooperative with each other so as to permit the adjustment of the relative position of the inner casing inside of the outer casing.

It is contemplated that there exist several different means for fixing the relative position of the inner casing within the outer casing. One such illustrative alternative means includes a locking nut which is threaded to match the second thread on the outer surface of inner casing. This allows the locking nut to move freely along second thread of the outer surface of the inner casing. When the locking nut is threadably engaged and adjustable relative to the inner casing the locking nut is adjustable such that the locking nut becomes frictionally engaged with the outer casing. Thus the relative position of the outer casing and inner casing are fixed by the thread locking action of the locking nut. One of skill in the art should appreciate that when the locking nut is fictionally disengaged from the outer casing, the relative position of the outer casing and inner casing can be adjusted.

Another alternative and illustrative means for fixing the relative position of the inner casing within the outer casing includes a compression type fitting arrangement. In such an illustrative embodiment the outer surface of the outer casing includes a third thread section. The outer casing also include one or more locking gaps, which are at least partially coextensive with the third thread. A compression nut whose thread is made to match the third thread on the surface of outer casing is designed such that when the inner casing is inserted into the outer casing from the end with gaps on it and the compression nut is threadably and adjustably fastened to the outer casing, the relative position of the outer casing and inner casing are fixed. One of skill in the art should appreciate that when the compression nut is not fastened to the outer casing, the inner casing can be moved relative to the outer casing.

Yet another alternative and illustrative embodiment of the means for fixing the relative position of the inner casing within the outer casing includes the use of locking screws. In one such illustrative embodiment one or more locking screw holes exist in the outer casing and are designed so that a locking screw is insertable into the locking screw hole. Thus when the inner casing is inserted into the outer casing from the end with locking screw holes, the locking screw is inserted into the locking screw hole. The locking screw is then rotated so as to frictionally engage the outer surface of the inner casing. This results in the fixing of the relative position of the outer casing and inner casing. One of ordinary skill in the art should understand and appreciate that when the locking screw is frictional disengaged from the outer surface, the inner casing can be moved relative in the outer casing.

The present invention also includes a reactor that incorporates the use of the thermocouple protection tube substantially described above. One of ordinary skill in the art should understand and appreciate that such an invention includes a reactor shell that defines a reaction zone, a thermocouple positioned relative to the reaction zone so as to permit the determination of the temperature of the reaction zone and a thermocouple protection tube as described above. In one such illustrative embodiment, the thermocouple protection tube includes: an outer casing, in which the outer casing has an inner surface and an outer surface, the outer casing includes a first thread on the inner surface of the outer casing; an inner casing, in which the inner casing has an inner surface and an outer surface, and means for fixing the relative position of the inner casing within the outer casing.

The inner casing is sized so as to be positioned inside the outer casing, and further the inner casing includes a second thread on the outer surface of the inner casing such that the first thread and the second thread are threadably cooperative with each other and thereby permit the adjustment of the relative position of the inner casing inside of the outer casing. Such an arrangement allows for the secure and precise adjustment of the position of the thermocouple relative to the reaction zone. The means for fixing the relative position of the outer and inner casing have been previously described in detail above.

While the apparatus and methods of this invention have been described in terms of preferred or illustrative embodiments, it will be apparent to those of skill in the art that variations may be applied to the process described herein without departing from the concept and scope of the invention. All such similar substitutes and modifications apparent to those skilled in the art are deemed to be within the scope and concept of the invention as it is set out in the following claims.

What is claimed is:

1. A thermocouple protection tube comprising:
an outer casing, wherein the outer casing has an inner surface and an outer surface,
an inner casing, wherein the inner casing has an inner surface and an outer surface, and
wherein the inner casing is sized so as to be positioned inside the outer casing, and
means for fixing the relative position of the inner casing within the outer casing.

2. The thermocouple protection tube of claim 1 wherein,
the outer casing includes a first thread on the inner surface of the outer casing, and
wherein the inner casing includes a second thread on the outer surface of the inner casing such that the first thread and the -second thread are threadably cooperative with each other and thereby permit the adjustment of the relative position of the inner casing inside of the outer casing.

3. The thermocouple protection tube of claim 1, wherein the means for fixing the relative position of the inner casing within the outer casing includes: a locking nut, wherein the locking nut includes a threading to match the second thread on the outer surface of inner casing so that the locking nut can move freely along second thread of the outer surface of the inner casing, and
wherein the locking nut is threadably engaged and adjustable relative to the inner casing such that when the locking nut is frictionally engaged to the outer casing, the relative position of the outer casing and inner casing are fixed and when the locking nut is fictionally disengaged from the outer casing, the relative position of the outer casing and inner casing is adjustable.

4. The thermocouple protection tube of claim 1 wherein the means for fixing the relative position of the inner casing within the outer casing includes: a third thread on the outer surface of the outer casing includes one or more locking gaps, wherein the locking gaps are at least partially coextensive with the third thread;
a compression nut whose thread is made to match the third thread on the surface of outer casing and
wherein inner casing is inserted into the outer casing from the end with gaps on it and the compression nut is threadably and adjustably fastened to the outer casing the relative position of the outer casing and inner casing are fixed and when the compression nut is not fastened to the outer casing, the inner casing can be moved relative to the outer casing.

5. The thermocouple protection tube of claim 1 wherein the means for fixing the relative position of the inner casing within the outer casing includes:
one or more locking screw hole in the outer casing and a locking screw insertable in said locking screw hole
wherein the inner casing is inserted into the outer casing from the end with locking screw hole and the locking screw is inserted into the locking screw hole, the locking screw frictionally engages the outer surface of the inner casing so as to fix the relative position of the outer casing and inner casing and when the locking screw is frictional disengaged from the outer surface the inner casing, the inner casing can be moved relative in the outer casing.

6. A reactor comprising:
a reactor shell that defines a reaction zone,
a thermocouple positioned relative to the reaction zone so as to permit the determination of the temperature of the reaction zone and
a thermocouple protection tube, wherein the thermocouple protection tube includes:
an outer casing, wherein the outer casing has an inner surface and an outer surface, the outer casing includes a first thread on the inner surface of the outer casing;
an inner casing, wherein the inner casing has an inner surface and an outer surface, and
wherein the inner casing is sized so as to be positioned inside the outer casing, and wherein the inner casing includes a second thread on the outer surface of the inner casing such that the first thread and the second thread are threadably cooperative with each other and thereby permit the adjustment of the relative position of the inner casing inside of the outer casing and
means for fixing the relative position of the inner casing within the outer casing.

7. The reactor of claim 6, wherein the means for fixing the relative position of the inner casing within the outer casing includes:
a locking nut, wherein the locking nut includes a threading to match the second thread on the outer surface of inner casing so that the locking nut can move freely along second thread of the outer surface of the inner casing, and
wherein the locking nut is threadably engaged and adjustable relative to the inner casing such that when the locking nut is frictionally engaged to the outer casing, the relative position of the outer casing and inner casing are fixed and when the locking nut is fictionally disengaged from the outer casing, the relative position of the outer casing and inner casing is adjustable.

8. The reactor of claim 6 wherein the means for fixing the relative position of the inner casing within the outer casing includes:
a third thread on the outer surface of the outer casing includes one or more locking gaps, wherein the locking gaps are at least partially coextensive with the third thread;
a compression nut whose thread is made to match the third thread on the surface of outer casing and
wherein inner casing is inserted into the outer casing from the end with gaps on it and the compression nut is threadably and adjustably fastened to the outer casing the relative position of the outer casing and inner casing are fixed and when the compression nut is not fastened to the outer casing, the inner casing can be moved relative to the outer casing.

9. The reactor of claim 6 wherein the means for fixing the relative position of the inner casing within the outer casing includes:
one or more locking screw hole in the outer casing and a locking screw insertable in said locking screw hole
wherein the inner casing is inserted into the outer casing from the end with locking screw hole and the locking screw is inserted into the locking screw hole, the locking screw frictionally engages the outer surface of the inner casing so as to fix the relative position of the outer casing and inner casing and when the locking screw is frictional disengaged from the outer surface, the inner casing can be moved relative in the outer casing.
